(19) United States
(12) Patent Application Publication
(10) Pub. No.: US 2009/0175467 A1
(43) Pub. Date: Jul. 9, 2009

(54) Audio Output Device and Controlling Method therefor

(76) Inventors: Nan-Jiun YIN, Hsinchu Science Park (TW); Yen-Hsien Su, Hsinchu Science Park (TW)

Correspondence Address: HDLS Patent & Trademark Services, P.O. BOX 220746, CHANTILLY, VA, 20153-0746, US

(21) Appl. No.: 12/114,748

(22) Filed: May 3, 2008

(30) Foreign Application Priority Data
Jan. 4, 2008 (TW) 097100475

(51) Int. Cl. H04B 15/00

(52) U.S. Cl. 381/94.5

(57) ABSTRACT

In an audio output device and controlling method therefor, the audio output device includes a power source, an audio processing unit and a power correction unit. The power source provides power for the audio output device. The audio processing unit processes audio signals. The power correction unit is coupled between the power source and the audio processing unit. The power correction unit corrects the supplied power by slowly charging or discharging for causing a frequency of a pulse audio signal being lower than 20 Hz, wherein the pulse audio signal is correspondingly obtained by the audio processing unit processing a power changing produced by turning on or turning off the power source.

### 1. FIELD OF THE INVENTION

The invention relates to an audio output device, especially relates to an audio output device and an audio output controlling method eliminating pulse audio signals.

### 2. DESCRIPTION OF THE RELATED ART

Conventional audio output devices such as microphones and speakers may output noise signals, which are pulse audio signals, when the audio output devices being turned on or turned off. At the moment that a power source of an audio output device being turned on or turned off, a supplied voltage of the power source suddenly rises to a certain value or suddenly falls, so that a waveform of the supplied voltage generates a sudden rising edge or a sudden falling edge. When the sudden rising edge or the sudden falling edge is provided to the audio output device, the audio output device generates a very shot pulse to generate a pulse audio signal, a pop noise, whereby the voice performance of the audio output device is influenced.

To eliminate the pulse audio signals, practitioners in the field have tried a lot of methods. FIG. 1 is a block diagram of a conventional audio output device. The audio output device 10 includes a power source 100, an audio processing unit 110, an audio output unit 120 and a transistor 130. The power source 100 provides power for the audio output device 10. The audio processing unit 110 processes audio signals. The audio output unit 120 outputs the processed audio signals. A drain electrode of the transistor 130 is connected to the joint of the audio processing unit 110 and the audio output unit 120. A source electrode of the transistor 130 is connected to the ground. A gate electrode of the transistor 130 is connected to a GPIO (Global Purpose Input/Output) control pin. When the power source 100 is turned on or turned off, the GPIO control pin sends a pulse signal to turn on or turn off the transistor 130 for eliminating the voltage pulse generated by turning on or turning off the power source, and then to eliminate the pulse audio signals.

However, the above method is not capable of eliminating the pulse audio signals completely. Referring to FIGS. 2A-2C, FIG. 2A is a voltage waveform diagram outputted from the power source 100 of FIG. 1, FIG. 2B shows a voltage waveform diagram outputted from the audio processing unit 110 when the transistor 130 is not configured to the audio output device 10, and FIG. 2C shows a voltage surge waveform diagram outputted from the audio processing unit 110 when the transistor 130 is configured to the audio output device 10. From FIG. 2C, we know that the transistor 130 reduces down the pulse voltage, but it is not capable of eliminating the pulse voltage completely. Thus, the problem of the pulse audio signals is not solved completely.

FIG. 3 shows an audio output device 30 applying another method to eliminate the pulse audio signals. A relay 350 is coupled between an audio processing unit 320 and an audio output unit 330 as a signal-delivering switch. A power source 310 supplies power to the relay 350 via a relay circuit 340. When the power source 310 is turned on, the relay 350 is still off because it is not capable of receiving the power immediately. Therefore, the pulse audio signals generated by a pulse voltage when the power source 310 being turned on is not capable of being delivered to the audio output unit 330. Thus, the user is not capable of hearing the pulse audio signals. When the power source 310 is turned off, the relay 350 is still off because it is not capable of receiving the power immediately. Therefore, the pulse audio signals generated by the pulse voltage when the power source 310 being turned off is not capable of being delivered to the audio output unit 330. Thus, the user is not capable of hearing the pulse audio signals.

However, though the audio output device 30 efficiently eliminates the pulse audio signals, the relay 350 still has many disadvantages of high energy consuming, big size and mechanism structure easy to be damaged, and so on.

What is need is an audio output device capable of eliminating pulse audio signals.

### BRIEF SUMMARY

The present invention is to provide an audio output device which is capable of eliminating pulse audio signals generated by turning on or turning off a power source.

The present invention is to provide an audio output controlling method which is capable of eliminating pulse audio signals generated by turning on or turning off a power source.

An embodiment of the present invention provides an audio output device, which includes a power source, an audio processing unit and a power correction unit. The power source provides power for the audio output device. The audio processing unit processes with audio signals. The power correction unit is coupled between the power source and the audio processing unit. The power correction unit corrects the supplied power by slowly charging or discharging for causing a frequency of a pulse audio signal being lower than 20 Hz, wherein the pulse audio signal is correspondingly obtained by the audio processing unit processing a power changing produced by turning on or off the power source.

According to one embodiment of the present invention, the power correction includes a resistor, a first charge storage component, a first controlled switch and a second controlled switch. The resistor includes a first end and a second end. The first end is electronically coupled to the power source to receive the supplied power from the power source. The first charge storage component includes a first end and a second end. The first end of the first charge storage component is electronically coupled to the second end of the resistor so that the power source is capable of charging the first charge storage component through the resistor. The first controlled switch includes a first end and a second end. The first end of the first controlled switch is electronically coupled to the power source to receive power from the power source, and whether the first end and the second end of the first controlled switch are conductive is determined by the voltage on the first end of the first charge storage component. The second controlled switch includes a first end and a second end. The first end of the second controlled switch is electronically coupled to the power source to receive power from the power source, and whether the first end and the second end of the second controlled switch are conductive is determined by the voltage of the second end of the first controlled switch.

According to another embodiment of the present invention, the power correction unit further includes a second charge storage component which includes a first end and a second end. The first end of the second charge storage component is electronically coupled to the second end of the second controlled switch so that the power source is capable of charging the second charge storage component through the second controlled switch.

An audio output controlling method for eliminating a pulse audio signal generated by turning on or turning off a power source is also provided, and the pulse audio signal is capable of being heard by human ears. The audio output controlling method includes slowing down the changing of the voltage outputted from the power source when turning on or turning off the power source for a frequency of a first pulse audio signal being low enough to a frequency range not heard by human ears, wherein the pulse audio signal is correspondingly obtained by the audio processing unit processing a power changing produced by turning on or off the power source.

Comparing with the conventional technology, the above audio output device and the audio output controlling method are capable of reducing the frequency of a pulse audio signal generated by turning on or turning off a power source to be lower than 20 Hz. Even that the pulse audio signal is not capable of being eliminated completely, the pulse audio signal is not capable of being heard by users because its frequency is low enough to a frequency range not heard by human ears. Furthermore, the audio output device consumes a lower energy and is not easy to be damaged.

Other objectives, features and advantages of the present invention will be further understood from the further technological features disclosed by the embodiments of the present invention wherein there are shown and described preferred embodiments of this invention, simply by way of illustration of modes best suited to carry out the invention.

### BRIEF DESCRIPTION OF THE DRAWINGS

These and other features and advantages of the various embodiments disclosed herein will be better understood with respect to the following description and drawings, in which like numbers refer to like parts throughout, and in which:

FIG. 1 is a block diagram of a conventional audio output device.

FIG. 2A is a voltage waveform diagram outputted from a power source of FIG. 1.

FIG. 2B is a voltage waveform diagram outputted from an audio processing unit when a transistor shown in FIG. 1 is not configured to the audio output device.

FIG. 2C is a voltage waveform diagram outputted from the audio processing unit when the transistor shown in FIG. 1 is configured to the audio output device.

FIG. 3 is a block diagram of another conventional audio output device.

FIG. 4 is a block diagram of an audio output device according to an embodiment of the invention.

FIG. 5 is a circuit diagram of a power correction unit according to another embodiment of the invention.

FIG. 6A is a voltage waveform diagram outputted from a power source shown in FIG. 4.

FIG. 6B is a voltage waveform diagram outputted from a power correction unit shown in FIG. 4 corresponding to the voltage waveform diagram shown in FIG. 6A.

FIG. 6C is a voltage waveform diagram outputted from an audio processing unit shown in FIG. 4 corresponding to the voltage waveform diagram shown in FIG. 6B.

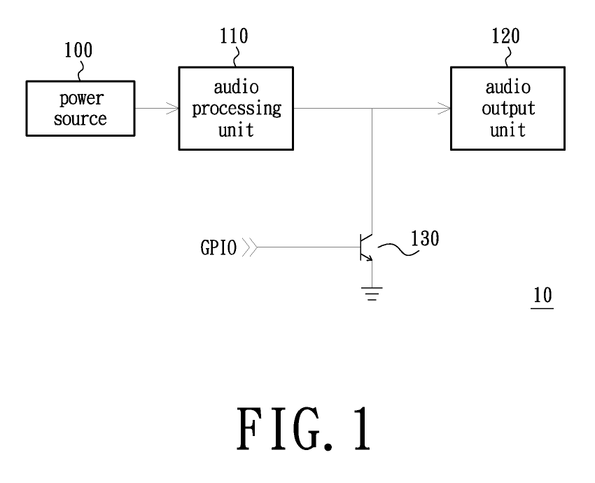

### DETAILED DESCRIPTION OF THE PREFERRED EMBODIMENTS

It is to be understood that other embodiment may be utilized and structural changes may be made without departing from the scope of the present invention. Also, it is to be understood that the phraseology and terminology used herein are for the purpose of description and should not be regarded as limiting. The use of “including,” “comprising,” or “having” and variations thereof herein is meant to encompass the items listed thereafter and equivalents thereof as well as additional items. Unless limited otherwise, the terms “connected,” “coupled,” and “mounted,” and variations thereof herein are used broadly and encompass direct and indirect connections, couplings, and mountings.

FIG. 4 shows a block diagram of an audio output device 40 according to an embodiment of the invention. In this embodiment, the audio output device 40 includes a power source 400, a power correction unit 410, an audio processing unit 420 and an audio output unit 430. The power source 400 provides power for the audio output device 40. The audio processing unit 420 processes audio signals. The power correction unit 410 is coupled between the power source 400 and the audio processing unit 420, and the power correction unit 410 corrects the supplied power by slowly charging or discharging for causing a frequency of a pulse audio signal being lower than 20 Hz, wherein the pulse audio signal is correspondingly obtained by the audio processing unit processing a power changing produced by turning on or turning off the power source 400.

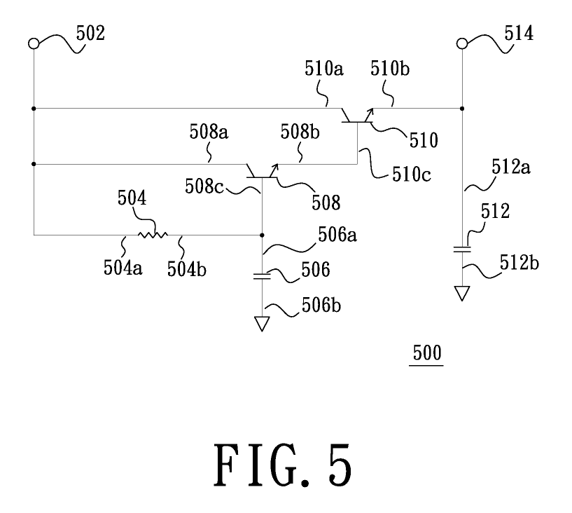

Referring to FIG. 5, a circuit diagram of a power correction unit 500 according to the invention is shown. In this embodiment, one end 502 of the power correction unit 500 is electrically coupled to the power source 400 shown in FIG. 4, and another end 514 of the power correction unit 500 is electronically coupled to the audio processing unit 420 shown in FIG. 4. The power correction unit 500 includes a resistor 504, a first charge storage component 506, a second charge storage component 512, a first controlled switch 508, and a second controlled switch 510. The first charge storage component 506 and the second charge storage component 512 shown in FIG. 5 are capacitors, but they are not limited to capacitors, they may be any other components with a characteristic that its output voltage increases when it is charged. The first controlled switch 508 and the second controlled switch 510 are not limited to transistors shown in FIG. 5, and they may be any other components with a characteristic that whether a first end and a second end are conductive with each other is determined by a voltage of a third end.

As shown in FIG. 5, a first end 504a of the resistor 504 is electronically coupled to the end 502 to receive power from the power source 400. A second end 504a of the resistor 504 is electronically coupled to a first end 506a of the charge storage component 506 and a control end 508c of the first controlled switch 508. A first end 506a of the first charge storage component 506 is electronically coupled to the resistor 504 so that the power source 400 is capable of charging the first charge storage component 506 through the resistor 504. A second end 506b of the first charge storage component 506 is coupled to the ground. A first end 508a of the first controlled switch 508 is electronically coupled to the end 502 to receive power form the power source 400. Whether the first end 508a and the second end 508b are conductive with each other is determined by the voltage of the controlled end 508c supplied by the first end 506a of the first charge storage component 506. Similarly, a first end 510a of the second controlled switch 510 is electronically coupled to the end 502 to receive power from the power source 400. Whether the first end 510a and a second end 510b are conductive with each other is determined by the voltage of the controlled end 510c, supplied by the second end 508b of the first controlled switch 508. When the second controlled switch 510 is turned on, the power source 400 begins to charge the second charge storage component 512 to provide power for the other circuits such as the audio processing unit 420.

According to the power correction unit 500, after charge the first charge storage component 506 when turning on the power source 400, the first controlled switch 508 and the second controlled switch 510 are turned on only in sequence. And after turning on the second controlled switch 510, the other circuit units such as the audio processing unit only receives power from the power source 400 to charge the second storage component 514. Therefore, the rising speed of the voltage supplied by the power source 400 is reduced down because of a slowly charging function provided by the power correction unit 500.

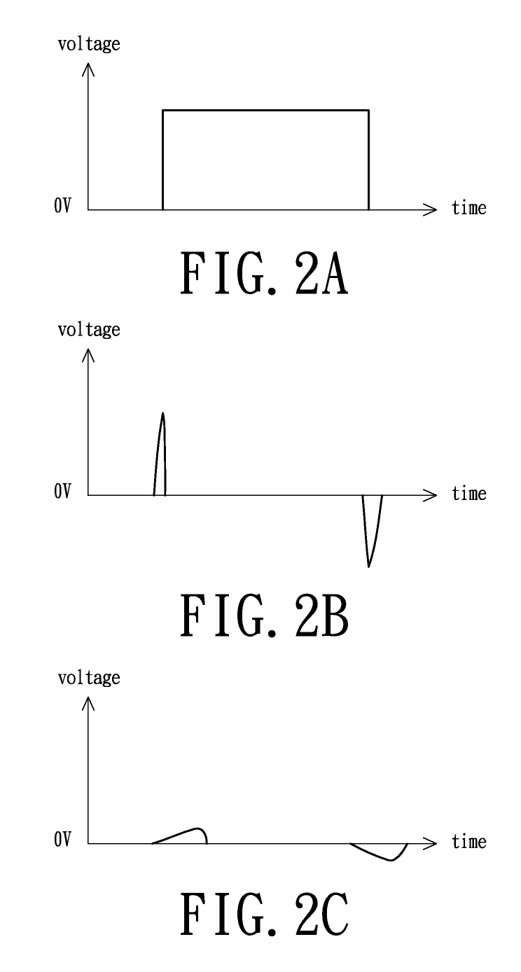

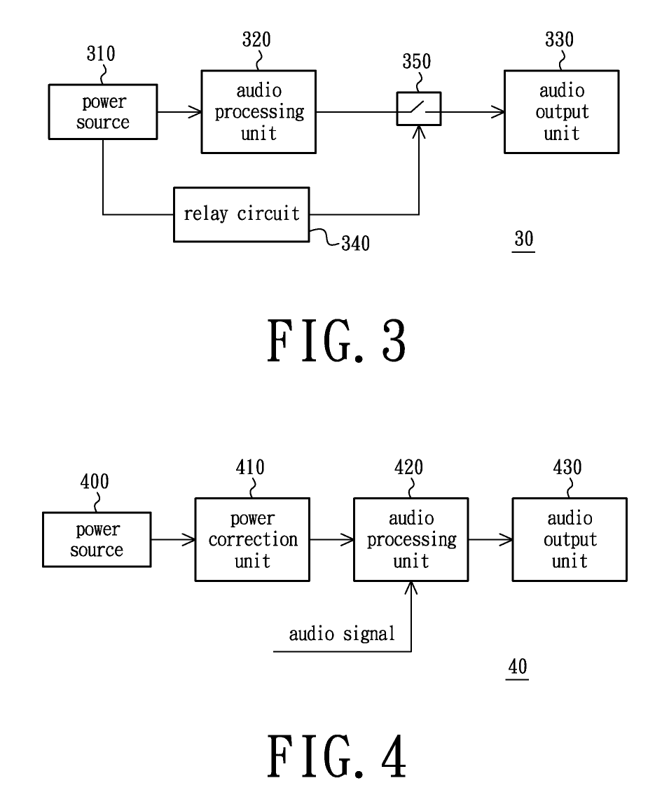

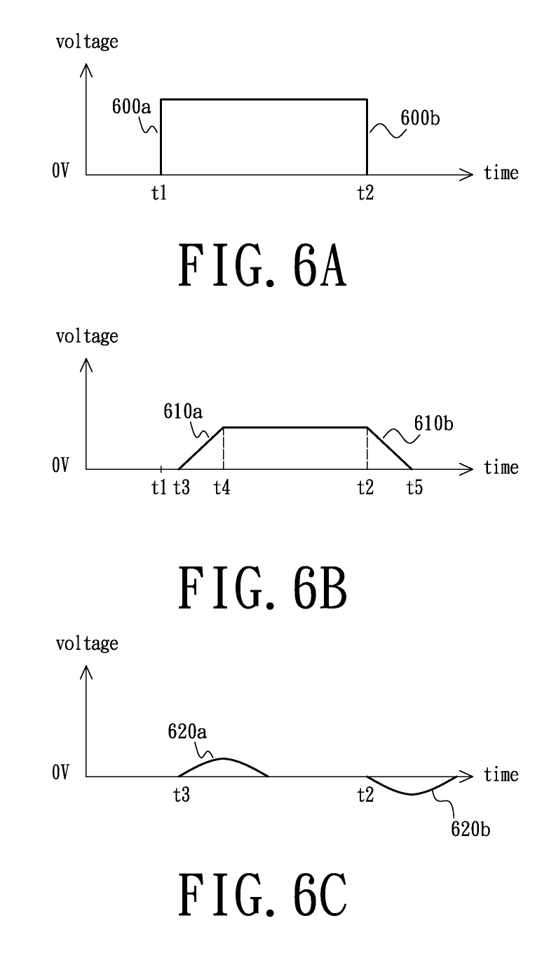

FIG. 6A shows a waveform diagram of the voltage supplied by the power source 400 shown in FIG. 4. The power source 400 begins to supply power with a rising edge 600a at time t1, and stops to supply power with a falling edge 600b. According to the rising edge 600a and the falling edge 600b, two voltage pulses are generated by the audio output unit 420 when turning on and turning off the power source 400, as shown in FIG. 2B. With a correction operation, the power correction unit 500 outputs voltages with a waveform having a slow rising voltage portion 610a and a slow falling voltage portion 610b, as shown in FIG. 6B. Due to the slow rising voltage and the slow falling voltage, the audio processing unit 420 outputs voltages with a waveform as show in FIG. 6C.

In detail, the controlled switch 508 is a transistor in one embodiment of the invention. The first end 508a and the second end 508b are not capable of being conductive with each other until the control end 508c has a high enough voltage. Therefore, when the power source 400 begins to supply power at time t1, the capacitor 506 is charged to a voltage high enough to conduct the first controlled switch 508 and the second controlled 510 in sequence at time t3. Then the second charge controlled switch 510 is conductive and the output voltage of the second charge storage component 512 increases gradually to a certain value at time t4 and forms a voltage waveform portion 610a. At time t2, the power source 400 stops to supply power. From t2 to t5 the second charge storage component 512 is discharged. Thus, the output voltage of the second charge storage component 512 decreases gradually from t2 to t5 and forms a voltage waveform portion 610b.

Due to the voltage waveform portion 610a and the voltage waveform portion 610b shown in FIG. 6B, the audio processing unit 420 generates a corresponding pulse audio signal 620a and a corresponding pulse audio signal 620b shown in FIG. 6C. The frequency of the pulse audio signal 620a and the frequency of the pulse audio signal 620b are reduced to a frequency lower than 20 Hz so that users are not capable of hearing the pulse audio signals. Therefore, the audio output device 40 completely eliminates the pulse audio signals capable of heard by human ears generated when turning on and turning off the power source 400.

An audio output controlling method is also provided in the invention. With the method, when the power source is turned on, the output voltage rises slowly so that a frequency of a pulse audio signal is lower than 20 Hz and users are capable of hearing the pulse audio signal. Similarly, when the power source stops to provide power, the output voltage falls slowly so that a frequency of a pulse audio signal is lower than 20 Hz and users are not capable of hearing the pulse audio signal.

The foregoing description of the preferred embodiments of the invention has been presented for purposes of illustration and description. It is not intended to be exhaustive or to limit the invention to the precise form or to exemplary embodiments disclosed. Accordingly, the foregoing description should be regarded as illustrative rather than restrictive. Obviously, many modifications and variations will be apparent to practitioners skilled in this art. The embodiments are chosen and described in order to best explain the principles of the invention and its best mode practical application, thereby to enable persons skilled in the art to understand the invention for various embodiments and with various modifications as are suited to the particular use or implementation contemplated. It is intended that the scope of the invention be defined by the claims appended hereto and their equivalents in which all terms are meant in their broadest reasonable sense unless otherwise indicated. Therefore, the term “the invention”, “the present invention” or the like does not necessarily limit the claim scope to a specific embodiment, and the reference to particularly preferred exemplary embodiments of the invention does not imply a limitation on the invention, and no such limitation is to be inferred. The invention is limited only by the spirit and scope of the appended claims. The abstract of the disclosure is provided to comply with the rules requiring an abstract, which will allow a searcher to quickly ascertain the subject matter of the technical disclosure of any patent issued from this disclosure. It is submitted with the understanding that it will not be used to interpret or limit the scope or meaning of the claims. Any advantages and benefits described may not apply to all embodiments of the invention. It should be appreciated that variations may be made in the embodiments described by persons skilled in the art without departing from the scope of the present invention as defined by the following claims. Moreover, no element and component in the present disclosure is intended to be dedicated to the public regardless of whether the element or component is explicitly recited in the following claims.

What is claimed is:

1. An audio output device for processing audio signals and outputting the processed signals, comprising:
a power source for supplying power for the audio output device;
an audio processing unit for processing the audio signals; and
a power correction unit electrically coupled between the power source and the audio processing unit, wherein the power correction unit corrects the supplied power by slowly charging or discharging for causing a frequency of a pulse audio signal being lower than 20 Hz, wherein the pulse audio signal is correspondingly obtained by the audio processing unit processing a power changing produced by turning on or turning off the power source.

2. The audio output device of claim 1, further comprising an audio output module electronically coupled to the audio processing unit to receive the processed audio signals from the audio processing unit, and to transfer the processed audio signals into voices to output the voices.

3. The audio output device of claim 1, wherein the power correction unit comprises:
a resistor comprising a first end and a second end, wherein the first end is electronically connected to the power source to receive the supplied power from the power source;
a first charge storage component comprising a first end and a second end, wherein the first end of the first charge storage component is electronically coupled to the second end of the resistor so that the power source is capable of charging the first charge storage component through the resistor;
a first controlled switch comprising a first end and a second end, wherein the first end of the first controlled switch is electronically coupled to the power source to receive power from the power source, and whether the first end and the second end of the first controlled switch are conductive is determined by the voltage on the first end of the first charge storage component;
a second controlled switch comprising a first end and a second end, wherein the first end of the second controlled switch is electronically coupled to the power source to receive power from the power source, and whether the first end and the second end of the second controlled switch are conductive is determined by the voltage on the second end of the first controlled switch; and
a second charge storage component comprising a first end and a second end, wherein the first end of the second charge storage component is electronically coupled to the second end of the second controlled switch so that the power source is capable of charging the second charge storage component through the second controlled switch.

4. The audio output device of claim 3, wherein each of the first charge storage component and the second charge component comprises a capacitor.

5. The audio output device of claim 3, wherein each of the first controlled switch and the second controlled switch comprises a transistor.

6. An audio output controlling method for eliminating a pulse audio signal generated by turning on or turning off a power source, the pulse audio signal is capable of being heard by users, the audio output controlling method comprising:
slowing down the changing of the voltage outputted from the power source when turning on or turning off the power source for a frequency of the pulse audio signal being low enough to a frequency range not heard by human ears, wherein the pulse audio signal is correspondingly obtained by the audio processing unit processing a power changing produced by turning on or turning off the power source.

7. The audio output controlling method of claim 6, wherein the frequency range not heard by human ears is lower than 20 Hz.

8. The audio output controlling method of claim 6, wherein the step of slowing down the changing of the voltage comprises slowing down the changing speed of the voltage rising edge by a slowly charging technology.

9. The audio output controlling method of claim 6, wherein the step of slowing down the changing of the voltage comprises slowing down the changing speed of the voltage falling edge by a slowly discharging technology.
